(19) United States
(12) Patent Application Publication
(10) Pub. No.: US 2004/0012481 A1
(43) Pub. Date: Jan. 22, 2004

(54) Closed parking lot for motor vehicles, equipment items therefor and management method

(76) Inventor: Thierry Brusseaux, Aveney (FR)

Correspondence Address: ROSENTHAL & OSHA L.L.P., 1221 MCKINNEY AVENUE, SUITE 2800, HOUSTON, TX, 77010, US

(21) Appl. No.: 10/296,347

(22) PCT Filed: May 25, 2001
(86) PCT No.: PCT/FR01/01632

(30) Foreign Application Priority Data
May 26, 2000 (FR) 00/06797

(51) Int. Cl. H04Q 1/00

(52) U.S. Cl. 340/5.7; 340/932.2

(57) ABSTRACT

The invention concerns a closed parking lot for motor vehicles (1) comprising means controlling entries and exits (2, 3, 5, 6), characterized in that said means controlling entries and exits (2, 3, 5, 6) co-operate with short range communication means, said short range communication means being adapted to interact with mobile radiotelephones (9) likewise equipped with short range communication means.

This invention relates to closed parking lots for parking cars or other vehicles. It covers the equipment required to make the parking lots, such as barrier control terminals and/or pay stations. The invention also covers the method for managing such parking lots.

Off-street parking lots with access control, where entrances and exits are controlled by barriers, and systems to pay parking fees, are now fairly common.

In public parking lots that are open to all users, motorists are issued upon entry into the system with magnetic stripe or barcode tickets containing data such as the date and time of entry and sometimes an identification number. The barrier is opened when the ticket is taken by the motorist, who can then enter the parking lot and park his or her vehicle. When the time comes to collect the vehicle and leave the parking lot, the motorist is asked to pay the parking fees by going to an automatic pay station or a manual counter, inserting the parking ticket and paying the fees calculated on the basis of the data recorded on the ticket. The ticket is re-encoded and returned to the motorist to enable him or her to open an exit barrier. In some cases, payment, particularly bank card payment, may be made at the exit terminal, which opens the exit barrier.

An increasing number of closed parking lots are now designed to enable the use of a subscription system, where subscribers are given parking cards that require contact or are of the contactless type. The cards are generally issued to a specific person and have an identifier to identify the subscriber. The subscriber presents the card at the entry and exit terminals to enjoy free access to the parking lot during the days and times covered by the subscription.

The different payment methods—tickets for occasional users and cards for subscribers—make the management system of such public parking lots more complex and therefore reduce profitability.

In private parking lots with reserved access such as residence parking lots, authorised users have a card or token that automatically opens the barriers or access gates. As with public parking lots, private cards require the use of access card management systems of variable complexity.

The aim of this invention is to simplify the management of closed parking lots by eliminating or at least reducing the use of parking tickets or access cards.

The closed parking lot based on the invention includes means controlling entries and exits.

In the invention, the parking lot is characterised by the fact that the said means controlling entries and exits work along with short-range communication means, which short-range communication means have the ability to interact with mobile radiotelephones that are also fitted out for short-range communication.

Another characteristic of the parking lot in the invention is that it includes an automatic pay station that works along with short-range communication means that have the ability to interact with mobile radiotelephones that are also fitted out for short-range communication.

A further characteristic of the parking lot in the invention is that the means controlling entries and exits work along with a management server that particularly supervises access to the said parking lot.

This invention also covers the entry and exit terminals that control the opening of entry and exit barriers of closed parking lots of the type described above.

In the invention, the entry or exit terminals that control the opening of entry or exit barriers of parking lots are characterised by the fact that they include short-range communication means, which short-range communication means have the ability to interact with mobile radiotelephones that are also fitted out for short-range communication.

This invention also covers the automatic pay stations that are required in closed parking lots of the type described above.

In the invention, the automatic pay stations of parking lots are characterised by the fact that they include short-range communication means that have the ability to interact with mobile radiotelephones that are also fitted out for short-range communication.

The invention also covers the method for managing closed parking lots of the type described above.

In the invention, the parking lot management method is characterised by the fact that to enter the parking lot, the user has to use a mobile telephone with a short-range communication facility to set off the transmission of a short-range radio message asking for entry into the said parking lot, where the message contains data relating to the identity of the user and can be processed by the means controlling entries, which check the content of the message and allow or deny access to the parking lot.

A further characteristic of the management method of the closed parking lot in the invention is that to leave the park, the user has to use a mobile telephone with a short-range communication facility to set off the transmission of a short-range radio message asking for exit from the said parking lot, where the message contains data relating to the identity of the user and can be processed by the means controlling exits, which check the content of the message and allow or deny exit from the parking lot.

Another characteristic of the management method of the closed parking lot in the invention is that the means controlling exits respond to the message asking for exit from the parking lot transmitted by the said mobile telephone by transmitting a short-range radio message asking for payment, where the payment request message can be processed by the said telephone.

Another characteristic of the management method of the closed parking lot in the invention is that the means controlling exits respond to the message asking for exit from the parking lot transmitted by the said mobile telephone by transmitting a message to the management server so that the server can charge the fees to the user.

Another characteristic of the management method of the closed parking lot in the invention is that the parking fees are debited from a prepaid account with the parking lot operator.

Another characteristic of the management method of the closed parking lot in the invention is that the prepaid account can be reloaded with a prepaid card.

Another characteristic of the management method of the closed parking lot in the invention is that the parking fees are charged to the user at the end of the month.

Another characteristic of the management method of the closed parking lot in the invention is that the means controlling exits send to the mobile telephone an electronic certificate with data relating to the parking time and cost.

The description below, which is illustrated by the attached drawing, is provided as a non-limitative example, in order to show the component elements of the invention and how it can be put in place.

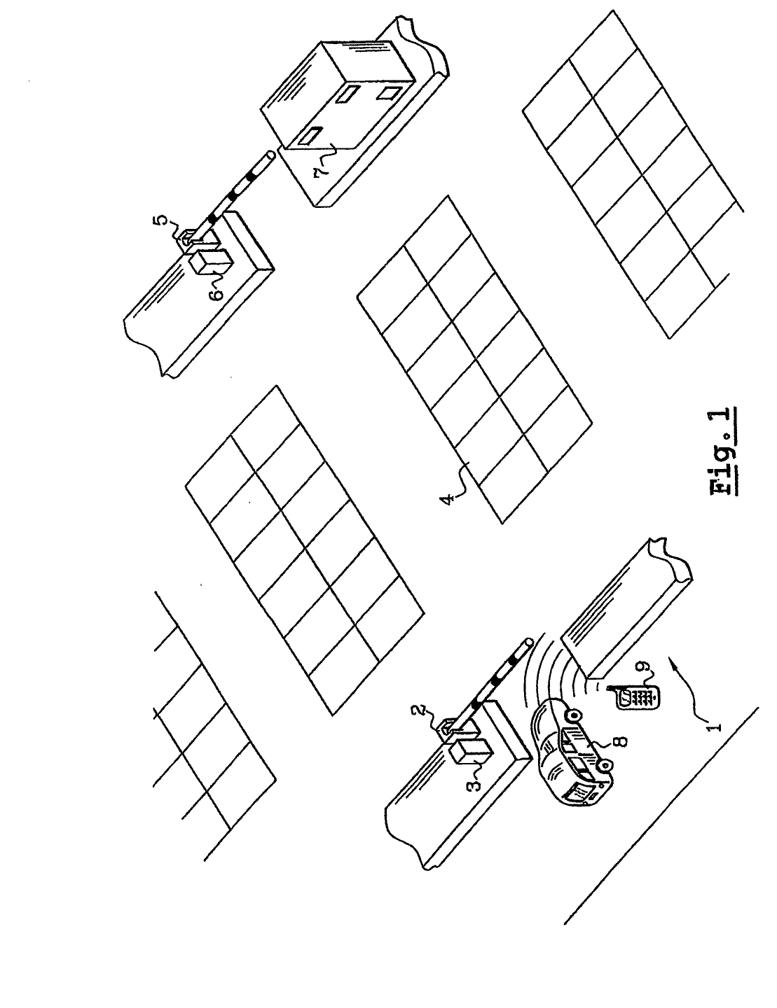

FIG. 1 is a principle diagram that shows how to set up a management method as in the invention.

The diagram in FIG. 1 particularly describes a public pay parking lot called parking lot 1. Parking lot 1 has at least one access closed by an entry barrier 2, which is opened by a corresponding entry terminal 3, a large open area in which the various parking spaces 4 are marked out, at least one exit closed by an exit barrier 5, which is opened by a corresponding exit terminal 6, and an automatic pay station 7. In another embodiment that is not illustrated, the barriers and their control terminals can be integrated into a single device. Likewise, in another mode of embodiment, the entry way is also used as the exit way, and the entry barrier is also the exit barrier.

Terminals 3 and 6 and pay station 7 are part of a parking system managed by a management server that is not shown, often called PMS (Parking Management System), to which the devices may be connected for example through a wired LAN. The management server, which essentially includes a computer and appropriate software, particularly enables the operator of parking lot 1 to supervise access to parking lot 1 and payment. In turn, it may be connected to a central computer that supervises several parking lots located in the same town or even in different towns.

In the invention, entry and exit terminals 3 and 6 of parking lot 1 each have means to receive and transmit radio signals. Such means may for instance take the form of a Bluetooth type interface that enables the terminals to communicate free of charge over a short range with at least one mobile telephone 9 that has the ability to handle such communication. Such interfaces made up of a radio receiver/transmitter module with an antenna are known and do not need more detailed description. The module communicates with the help of a radio communication peripheral with a CPU located in the terminal, which includes a microprocessor and memories and processes the data received and transmitted. Further, the microprocessor works along with the means to transmit and receive messages to and from the management server.

A user of parking lot 1 who wishes to use the radio communication function of entry and exit terminals 3 and 6 of parking lot 1 must also have a corresponding transmitter-receiver unit, which is particularly able to transmit identification and/or payment data that can be recognised by terminals 3 and 6.

In the invention, the unit is a radiotelephone 9 capable of short-range transmissions outside the pay phone network such as a radiotelephone with the Bluetooth function. The distribution of such radiotelephones is becoming more widespread, particularly in the form of a unit that is directly integrated into automobile dashboards. New generation radiotelephones that are suited to mobile radiotelephony networks of all types—GSM, CDMA, TDMA, AMPS, D-AMPS or PCS—all include transmitters-receivers for long-range communication in pay networks and also transmitters-receivers for short-range communication between electronic devices, such as between a telephone and a computer. Such short-range transmitters-receivers are particularly known by the name Bluetooth. Short-range communication offers the added advantage of being free of charge.

The radiotelephone 9 used to interact with the terminals of parking lot 1 and control the opening of barriers has appropriate application software loaded in the integrated circuits of the telephone or its SIM (Subscriber Identity Module) card, which contains a microcontroller or in which the data required for accessing the radiotelephony network are stored.

The application software is available from the operator of parking lot 1 and is loaded into the mobile telephone from an appropriate loading terminal, which may for example be integrated into pay station 7, or from a site available at a given telephone number.

Besides, the radiotelephone 9 used to control the opening of barriers may advantageously include a bank (or credit) card reader or reader of prepaid cards such as electronic purses for the immediate payment applications detailed below.

In accordance with the above description of parking lot 1, the method for controlling access to the parking lot and payment is as follows in the invention.

The motorist, who wants to park his/her car 8 arrives at parking lot 1, drives up to entry barrier 2 and presses a key on the corresponding entry terminal 3 to enable the terminal to receive short-range communication. Of course, pressing a key is not a limitative feature of the invention. For instance, the entry terminal may be set up so as to listen out continuously for short-range radio communication, in which case the motorist only has to roll down the window.

The motorist then enters a preset code on the keypad of his/her mobile telephone 9 to activate the application software. That generates the transmission of a short-range radio message to entry terminal 2, which access request message contains data, particularly about the identity of the motorist. The message is received by entry terminal 2 and is transmitted to the associated microcontroller. The microcontroller checks if the identifier of the motorist is recognised by the system, either offline against the lists loaded into terminal 2 or online against the data in the management server.

If the identifier is recognised, the microcontroller opens entry barrier 2. At the same time, in a particular mode of embodiment of the invention, the microcontroller sends a short-range communication message to mobile telephone 9 (or the SIM card) with data such as the identification of the parking lot and the date and time of entry. The electronic passage certificate is stored in mobile phone 9 and may be used as evidence if there is any problem (system fault etc.) so that the motorist can leave after paying for the actual parking time. The microcontroller of entry terminal 2 also sends data such as the identifier of the motorist and the date and time of entry to the management server.

If the identifier is not recognised, the gate does not open.

The procedure for leaving the parking lot is significantly similar to that of entry. The motorist drives up to exit barrier 5 and may be required to press a key on exit terminal 6 to enable it to receive short-range communication. The motorist then uses his/her mobile telephone 9 to enter a preset code, which may be the one used before. That transmits a short-range radio signal to exit terminal 6, which exit request message particularly contains the identifier of the motorist and possibly the date and time of entry into parking lot 1 contained in the passage certificate.

The exit request message is received by exit terminal 6 and transmitted to the associated microcontroller. As with the check by terminal 2, the microcontroller of terminal 6 checks if the identifier is recognised by the system. If the identifier is not recognised, exit barrier 5 remains closed. In particular, the check prevents vehicle theft.

If the identifier is recognised, the microcontroller proceeds to verify the associated payment method. The check is performed either offline with the help of the lists loaded into terminal 6 or online by calling the management server. The payment may be of the deferred type, where the user has a subscription or account that is debited at the end of the month. In that case, the microcontroller simply opens barrier 5 and sends the management server the data required for charging the parking fees. Alternatively, payment may be immediate and the microcontroller checks with the management server if payment has been made. If so, the microcontroller opens barrier 5. Otherwise, it sends a payment request message to mobile telephone 9.

Regardless of the payment mode, the microcontroller of exit terminal 6 may send mobile telephone 9 an electronic certificate calculated at least on the basis of user data, such as the subscription number or account number, information identifying the place of parking and data relating to the parking time, cost and the total cost over the month. The certificate is stored in the memory of the telephone or in the SIM card, preferably by overwriting the aforementioned passage certificate, which is only temporarily useful. If the memory is sufficient, several certificates may be stored in an appropriate file.

The certificate acts as the proof of payment held by the motorist in the event of any problem. The motorist can go to the parking system operator with his or her mobile telephone and prove that payment has been made with the help of the certificate stored in the memory.

As pointed out before, different payment methods may be used.

In order to be able to use the deferred payment services, the motorist registers with the parking lot operator and selects the conditions of access to parking lot 1. The operator issues the motorist with identification and an application to be loaded in mobile telephone 9 or the SIM card. Of course, the invention is not limited to the loading of a specific application. For instance, if the telephone already has a Bluetooth application such as an application for sending an identification signal (SIM card number, for instance) when a key or a sequence of keys is pressed on the phone keypad, that preexisting function may be used to enable access to the parking lot. In this case, the sending of the identification signal will lead to the opening and closing of barriers.

With a prepaid subscription for a set duration, the motorist can freely enter the parking lot and leave it on authorised days at the authorised times. To enter or leave the parking lot, the motorist merely sends a short-range telephone message by entering a predetermined code on the keypad of mobile telephone 9. Entry and exit terminals 2 and 6 control access and transmit the corresponding data to the management server.

If the subscriber has an account from which the actual parking fees are debited at the end of the month, the motorist enters parking lot 1 and leaves it by entering a predetermined code on the keypad of his/her mobile telephone 9 to transmit the identifier to entry and exit terminals 3 and 6. The entry and exit data are transmitted to the management system, which keeps track of the parking time and therefore the amount due for each identifier. The price to be paid by the motorist is calculated on the basis of the applicable tariff and the parking duration data obtained by calculating the difference between the start and end of parked time. At the end of the month, the motorist receives a statement and a bill, to be paid directly to the operator of parking lot 1.

In order to use prepayment services, the motorist must also register with the operator of parking lot 1. The operator issues the motorist with an identifier and the application to be loaded in mobile telephone 9 or the SIM card. Prepayment consists in opening an account with the management server and paying a given amount in advance. The operation may for instance be performed directly from pay station 7, which also has a short-range communication interface of the Bluetooth type. When the motorist goes past exit barrier 6, the parking fees are debited from his/her account. When the account is depleted, it must be reloaded.

Accounts could also be reloaded by purchasing a prepaid scratch card offering, say, FF 100 of parking. The motorist then calls the parking system with his/her mobile telephone and enters the number provided on the scratch card. The data are transmitted to the parking server and the amount of FF. 100 is credited to the prepaid account of the motorist.

Alternatively, immediate payment can be effected if the mobile telephone 9 contains a reader for electronic purses or bank cards in order to enable immediate transactions via the telephone. In that case, when the car leaves parking lot 1, terminal 6 sends mobile telephone 9 (or the SIM card) a short-range communication message asking for payment of the amount due.

The user inserts his/her e-purse or bank card in the reader of the mobile telephone and makes a secure payment through the secure link with terminal 6, which saves the transaction and debits the amount from the card. Of course, known methods for validating and authenticating payment cards may also be used by terminal 6 and the management server. These methods are not covered by the invention and shall not be detailed. Once the payment has been received and a receipt is sent to telephone 9, terminal 6 raises barrier 5.

If telephone 9 does not have a card reading slot and immediate payment is desired, that may be done with the help of automatic pay station 7, which is also fitted with a Bluetooth type short-range communication module for that purpose.

Before leaving the parking lot, the motorist drives up to automatic pay station 7 and may need to press a key to enable the pay station to receive short-range communication. The motorist then enters the appropriate code on his/her mobile telephone 9, which generates the transmission of a short-range communication radio message to pay station 7, with the identifier of the motorist and possibly the date and time of entry into parking lot 1.

The message is received by pay station 7 and transmitted to the microcontroller integrated into pay station 7. As with the check by the entry and exit terminals, the microcontroller of pay station 7 checks if the identifier is recognised by the system. If that is not so, pay station 7 transmits or displays a warning message to the motorist.

If the identifier is recognised, the microcontroller calculates the parking fees, either offline on the basis of the tariffs loaded and the entry date and time provided by telephone 9 or online by logging on to the management server. The motorist simply pays the amount due using ordinary methods. As soon as the payment is made, the pay station sends a short-range communication message to telephone 9, informing it that payment has been made and also informs the management server.

The motorist drives up to exit barrier 5 and enters the appropriate code on his/her mobile telephone, which leads to the transmission of a short-range communication message to associated terminal 6, containing in particular the identifier of the motorist. The microcontroller of terminal 6 checks the identifier and calls the server to find out if payment has been made. If that is so, it opens barrier 5.

The invention make is possible to use mobile phones to control access to parking lot 1, effect payment and transmit information. The invention offers a number of advantages to parking lot operators and to motorists who use the parking lots. Operators can expect to reduce the use of subscriber and short-term tickets issued by entry terminals 2, in order to cut the costs related to operating and payment management. Electronic transactions reduce the management and handling of cash (collection, reloading etc.) and thereby heighten security. The motorists can access the parking lots and make payments more easily and their mobile telephones become true remote controls for barriers.

Of course, the illustrated embodiment mode is only an example and does not limit the solutions that can be put in place with the help of this invention in any way.

This invention may also be used in private parking lots, where access is possible by means of a simple mobile telephone with short-range communication means.

1. A closed parking lot for vehicles (1) with means controlling entries and exits (2,3; 5,6), characterised by the fact that the said means controlling entries and exits (2,3; 5,6) work along with short-range communication means that can interact with mobile radiotelephones (9) likewise equipped with short-range communication means.

2. A parking lot (1) as described in claim 1, characterised by the fact that it includes an automatic pay station (7), which works along with short-range communication means that can interact with mobile radiotelephones (9) likewise equipped with short-range communication means.

3. A parking lot (1) as described in claim 1 or 2, characterised by the fact that the said means controlling entries and exits (2,3; 5,6) work along with a management server that particularly supervises access to the said parking lot (1).

4. An entry or exit terminal (3, 6) that controls the opening or closing of an entry or exit barrier (2, 5) of a closed parking lot as described in any claim from 1 to 3, characterised by the fact that it includes short-range communication means that can interact with mobile radiotelephones (9) likewise equipped with short-range communication means.

5. An automatic pay station for a closed parking lot as described in any claim from 1 to 3, characterised by the fact that it includes short-range communication means that can interact with mobile radiotelephones (9) likewise equipped with short-range communication means.

6. A management method for a closed parking lot as described in any claim from 1 to 3, characterised by the fact that to enter the parking lot (1), a motorist with a said mobile telephone (9) uses the said telephone (9) to transmit a radio message asking for entry to the said parking lot (1) using the said short-range communication, where the said entry request message contains data relating to the identity of the motorist and can be processed by the said means controlling entries (2, 3) which means controlling entries enable the vehicle of the motorist to enter the parking lot (1) after verifying the content of the said message.

7. A management method for a closed parking lot as described in claim 6, characterised by the fact that to leave the parking lot (1), a motorist with a said mobile telephone (9) uses the said telephone (9) to transmit a radio message asking for exit from the said parking lot (1) using the said short-range communication, where the said exit request message contains data relating to the identity of the motorist and can be processed by the said means controlling exits (5, 6), which means controlling exits enable the vehicle of the motorist to leave the parking lot (1) after verifying the content of the said message.

8. A management method for a closed parking lot as described in claim 7, characterised by the fact that the said means controlling exits (5, 6) respond to the exit request message from the said mobile telephone (9) by generating a payment request radio message using the said short-range communication, which payment request message can be processed by the said telephone (9).

9. A management method for a closed park as described in claims 3 and 7, characterised by the fact that the said means controlling exits (5, 6), respond to the exit request message from the said mobile telephone (9) by generating a message to the management server asking it to charge the motorist.

10. A method as described in claim 9, characterised by the fact that the parking fees are debited from a prepaid account with the operator of parking lot (1).

11. A method as described in claim 10, characterised by the fact that the said prepaid account can be recharged with a prepaid card.

12. A method as described in claim 9, characterised by the fact that parking fees are charged to the motorist at the end of the month.

13. A method as described in any claim from 6 to 9, characterised by the fact that the said means controlling exits (5, 6) send the said mobile telephone (9) an electronic certificate with data relating to the parking time and fees.
